(19) United States
(12) Patent Application Publication
(10) Pub. No.: US 2006/0069645 A1
(43) Pub. Date: Mar. 30, 2006

(54) Method and apparatus for providing secured content distribution

(76) Inventors: Annie Chen, Del Mar, CA (US); John Okimoto, San Diego, CA (US); Lawrence Tang, San Diego, CA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/216,335

(22) Filed: Aug. 31, 2005

Related U.S. Application Data
(60) Provisional application No. 60/605,966, filed on Aug. 31, 2004.

(51) Int. Cl. H04L 9/00

(52) U.S. Cl. 705/51; 705/57

(57) ABSTRACT

A method and apparatus for providing secured content distribution using a media hub is disclosed. In one embodiment, conditional access encrypted content is received at the media hub. The conditional access encrypted content is decrypted. The content is re-encrypted in accordance with a unique tier associated with the media hub and one or more devices in response to a request from at least one device associated with the unique tier. The re-encrypted content is provided to the at least one device in response to the request from the at least one device associated with the unique tier. A method and apparatus for providing secured content distribution is disclosed. In one embodiment, unit addresses (UAs) of all components within a home media architecture are obtained. A unique key is generated for the home media architecture using public information from the UA of each component. A message including the unique key is distributed to each component of the home media architecture. A method and apparatus for providing secured content distribution is disclosed. In one embodiment, UAs of all decoders within a home media architecture are obtained. A unique key is generated for the home media architecture using public information from the UA of each decoder. A message including the unique key is distributed to each decoder of the home media architecture.

### CROSS-REFERENCE TO RELATED APPLICATIONS

This application claims the benefit of U.S. provisional patent application No. 60/605,966, filed Aug. 31, 2004, which is herein incorporated by reference.

### BACKGROUND OF THE INVENTION

1. Field of the Invention

The present invention relates to conditional access content distribution. In particular, this invention relates to a method and apparatus for providing secured content distribution within a home media architecture.

2. Description of the Related Art

A home media architecture (HMA) comprises multiple decoders inside a home. Content is sent through the network and may be stored on a personal video recorder (PVR). At a later time, one of the decoders may request to view stored content.

The system implementing video on demand (VOD) provides the capability to limit content access to authorized subscribers only, as the contents delivered as part of the service are generally considered valuable intellectual properties by their owners. In cable and satellite television, such capability is known as conditional access. Conditional access requires a trustworthy mechanism for classifying subscribers into different classes, and an enforcement mechanism for denying access to unauthorized subscribers. Encryption is typically the mechanism used to deny unauthorized access to content (as opposed to carrier signal).

In a cable system, carrier signals are broadcast to a population of subscriber terminals (also known as set-top boxes). To prevent unauthorized access to service, encryption is often employed. When content is encrypted, it becomes unintelligible to persons or devices that don't possess the proper cryptographic key(s). A fundamental function of a conditional access system is to control the distribution of keys to the population of subscriber terminals, to ensure that each terminal can compute only the keys for the services for which it is authorized. Traditionally, in broadcast services, an encryption device is placed on the signal path before the signal is placed on the distribution network. Thereafter, the encryption device encrypts the signal and its contents in real time. This technique is acceptable because a large number of subscribers share the same (relatively small number of) content streams.

Media Cipher 2.1 is one type of conditional access encryption/decryption method currently used for securing content within a HMA. However, there are over twenty million legacy decoders that use Media Cipher 1.7 instead of Media Cipher 2.1.

Therefore, there is a need in the art for a solution to encrypt content such that legacy decoders can decrypt the content and components that are not part of the HMA cannot decrypt the content.

### SUMMARY OF THE INVENTION

The present invention discloses a method and apparatus for providing secured content distribution using a media hub. In one embodiment, conditional access encrypted content is received at the media hub. The conditional access encrypted content is decrypted. The content is re-encrypted in accordance with a unique tier associated with the media hub and one or more devices in response to a request from at least one device associated with the unique tier. In response to said request from at least one device, the re-encrypted content is provided to the at least one device.

A method and apparatus for providing secured content distribution is disclosed. In one embodiment, unit addresses (UAs) of all components within a home media architecture are obtained. A unique key is generated for the home media architecture using public information from the UA of each component. A message including the unique key is distributed to each component of the home media architecture.

A method and apparatus for providing secured content distribution is disclosed. In one embodiment, UAs of all decoders within a home media architecture are obtained. A unique key is generated for the home media architecture using public information from the UA of each decoder. A message including the unique key is distributed to each decoder of the home media architecture.

### BRIEF DESCRIPTION OF THE DRAWINGS

FIG. 1 illustrates a diagram of a system for providing secured content distribution according to one embodiment of the present invention;

FIG. 2 illustrates a diagram of a method for providing secured content distribution according to one embodiment of the present invention;

FIG. 3 illustrates a diagram of a method for providing secured content distribution according to one embodiment of the present invention; and

### DETAILED DESCRIPTION

Disclosed is a method and apparatus for securely streaming content from one component, e.g., a media hub, to another component, e.g., a media terminal, within a home media architecture (HMA). The methods for securely streaming content described herein apply to media terminals that comprise digital consumer terminals (DCTs) with Media Cipher 1.7 or older security chips, Media Cipher 2.1 DCTs, and media terminals that include X.509 certificates. The methods described herein also apply to DCTs with other conditional access security chips.

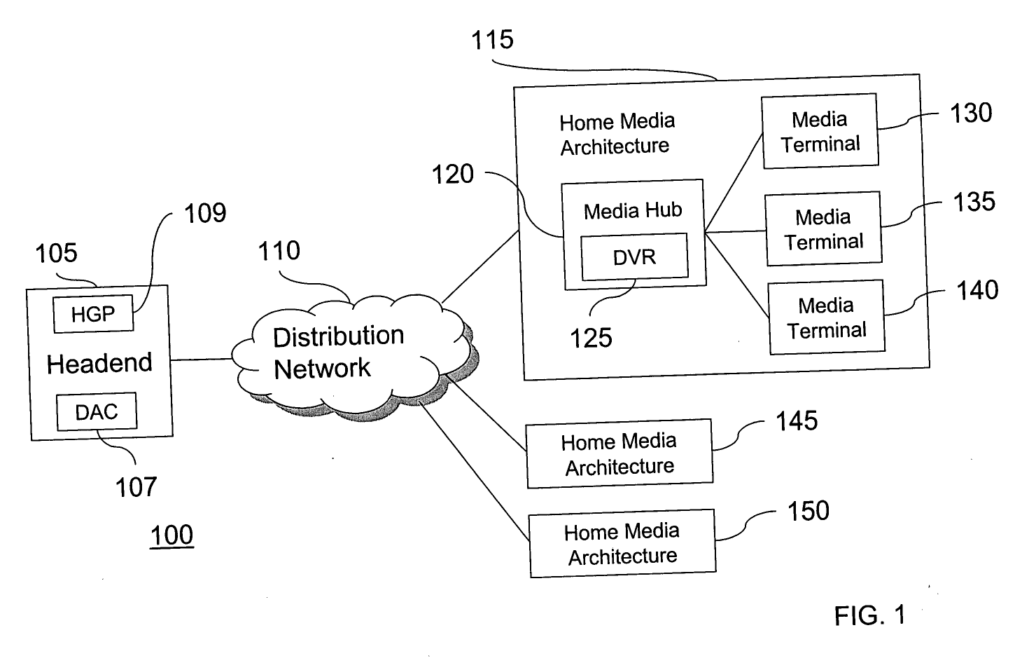

FIG. 1 illustrates a block diagram of a system 100 for delivering secured content according to one embodiment of the present invention. System 100 comprises a headend 105, a distribution network 110, and a plurality of home media architectures (HMAs) 115, 145, 150. Headend 105 distributes conditional access (CA) encrypted content via distribution network 110 to the plurality of HMAs 115, 145, 150. HMA 115, 145, 150 may comprise a media hub 125 and one or more media terminals 130, 135, 140. Headend 105 includes digital access controller (DAC) 107. DAC 107 may be used to distribute a channel map to components within each HMA 115, 145, 150. DAC 107 may also be utilized to set components within each HMA in interactive mode and initialize components within each HMA. In one embodiment, DAC 107 distributes category keys to each component within an HMA. In one embodiment, headend 105 also includes Home Group Provisioner (HGP) 109 for creating and distributing a unique key to all the components belonging to one HMA. Media hub 120 includes digital video recorder (DVR) 125 for securely storing content received from headend 105. Although media hub 120 is only shown providing content to media terminals 130, 135, 140, media hub 120 may also be configured to provide data networking and voice over internet protocol (VOIP) capability. In one embodiment media hub 120 may comprise a router for providing near real-time conditional access to encrypted content (e.g., streaming, internet protocol (IP)) to one or more media terminals 130, 135, 140.

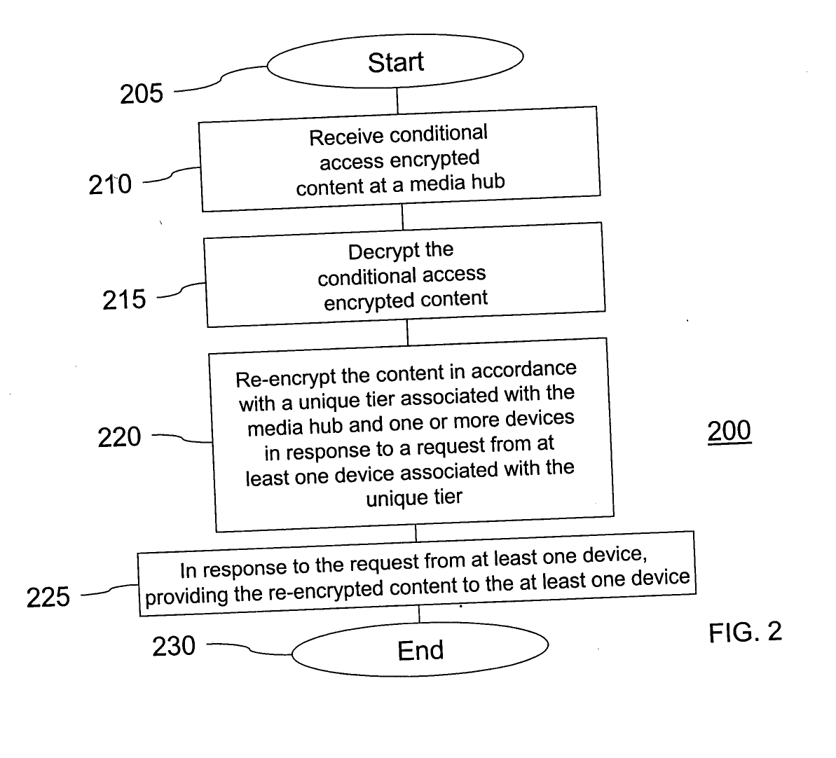

FIG. 2 illustrates a diagram of a method 200 for providing secured content distribution according to one embodiment of the present invention. FIG. 2 begins at step 205 and proceeds to step 210. At step 210, conditional access (CA) encrypted content is received at media hub 120. At step 215, the CA encrypted content is decrypted. At step 220, the content is re-encrypted in accordance with a unique tier associated with media hub 120 and one or more devices 130, 135, 140 in response to a request for content from at least one device associated with the unique tier. Media hub 120 may utilize fixed key encryption or full encryption. When fixed key encryption is used, media hub 120 encrypts the content with either fixed working key or fixed program key using a predefined Entitlement Control Message (ECM) template.

In a conditional access system, each content stream is associated with a stream of ECMs that serve two basic functions: (1) to specify the access requirements for the associated content stream (i.e., what privileges are required for access for particular programs); and (2) to convey the information needed by subscriber terminals to compute the cryptographic key(s), which are needed for content distribution. ECMs are transmitted in-band alongside their associated content streams. Typically, ECMs are cryptographically protected by a “monthly key” which changes periodically, usually on a monthly basis. The monthly key is typically distributed by entitlement management messages (EMMs) prior to the ECMs.

Entitlement management messages (EMMs) are control messages that convey access privileges to subscriber terminals. Unlike ECMs which are embedded in transport multiplexes and are broadcast to multiple subscribers, EMMs are sent unicast-addressed to each subscriber terminal. That is, an EMM is specific to a particular subscriber. In a typical implementation, an EMM contains information about the monthly key, as well as information that allows a subscriber terminal to access an ECM which is sent later. EMMs also define the tiers for each subscriber. With reference to cable services, for example, a first EMM may allow access to HBO™, ESPN™, and CNN™. A second EMM may allow access to ESPN™, TNN™, and BET™, etc. In one embodiment, the EMM may comprise a content rekey message (CRKM).

When full encryption is used, all DCT's (media hub and media terminals) share the same category key. This category key is distributed by DAC 107.

At step 225, in response to said request from one or more devices, the re-encrypted content is provided to the at least one device. Media hub 120 controls the content streaming according to commands (e.g., pause, rewind, fast forward) from the requesting media terminal(s) 130, 135, 140. Media terminals 130, 135, 140 may decrypt CA encrypted content when not requesting playback from media hub 120.

In one embodiment, once media hub 120 CA decrypts the content, the content is personal video recorder (PVR) encrypted and stored on DVR 125. In response to a request from one of the media terminals 130, 135, 140, the PVR encrypted content is retrieved from DVR 125 and PVR decrypted. The PVR decrypted content is then provided to media hub 120, where the content is re-encrypted in accordance with a unique tier.

In one embodiment, within one HMA, the media hub encryptor and media terminals share a unique tier, e.g., an In-Home Tier (IHT), that is not part of broadcast services. When the media hub encrypts content to be distributed, the media hub creates an ECM using the IHT. In one embodiment, the ECM comprises a program rekey message (PRKM) and a working key epoch message (WKEM) that call for full encryption. The ECM includes the IHT as one of its authentication fields. Since all media terminals within a particular HMA are authorized for a particular IHT, any media terminal within the HMA is capable of decrypting the playback content. In this embodiment, the DAC gives media terminals within a particular HMA an IHT. As such, media terminals from another HMA cannot decrypt the content without permission from the DAC. A neighbor's media terminal, e.g., a terminal connected to HMA 145, 150, cannot decrypt the encrypted signal since it does not have the IHT. The multiple system operator (MSO) controls the HMA configuration.

An example of an embodiment using full encryption will now be described. Broadcast Services (BS) tells the DAC which components belong to one HMA, e.g., the UA of the media hub decryptor, the list of media terminal decryptors, the media hub encryptor, and which services the HMA has ordered. DAC assigns a unique IHT for this HMA and creates a category rekey message (CRKM) for each component carrying the IHT and other services as described below. There is no change to the creation of ECM for broadcast services. The media hub creates the ECM that handles the encryption of playback content as described below. The media hub does not create a CRKM.

When a media hub moves to another HMA within the same cable network, the DAC is notified of the new HMA configuration via BS. DAC creates new CRKMs for the new media terminals that have become part of this media hub's HMA. DAC uses the same IHT algorithm to derive the IHT to be included in the CRKMs. Depending on how IHT is derived, there may be no change to the CRKM for the media hub encryptor. Once the CRKMs are received by the new set of media terminals, these media terminals will be able to decrypt the playback contents stored on the media hub PVR, e.g., DVR 125.

The DAC creates CRKMs for each component as follows. A CRKM is created for the media hub decryptor with all signed-up, e.g., ordered, broadcast services. An IHT for this account is computed using an algorithm that gives a high probability of uniqueness within a cable population. For example, a bank of tiers that will not be used by BS may be reserved. Real time video on demand (VOD) session encryption scheme already has a bank of tiers that is not used by BS. The unit address of one of the security elements in the HMA (e.g., media hub encryptor/decryptor, media terminal decryptor) may be used and mapped into this bank. A CRKM is created for the media hub encryptor with IHT. A CRKM is also created for the media terminal(s) with signed-up broadcast services plus the IHT. The CRKMs are sent to all the security elements in the HMA.

In one embodiment, in the media hub, a decryptor decrypts CA encrypted content. The media hub PVR encrypts the content and stores on a PVR. When a media terminal requests a particular content, the media hub creates a unique PRKM and WKEM (ECM set). The media hub PVR decrypts the content and conditional access encrypts using the newly created ECM set, e.g., the ECM set created for the HMA IHT. The conditional access encrypted content is then streamed to the requesting media terminal. In one embodiment, the conditional access encryption performed by the media hub comprises Media Cipher (MC) encryption.

In one embodiment, a template for the ECM set may be programmed ahead of time. The only tier in the PRKM is the IHT that must be computed using the same algorithm used by the DAC. In this embodiment a unique key is created per encryption. Security-wise, the media terminal(s) do not distinguish between broadcast service and playback content in this embodiment.

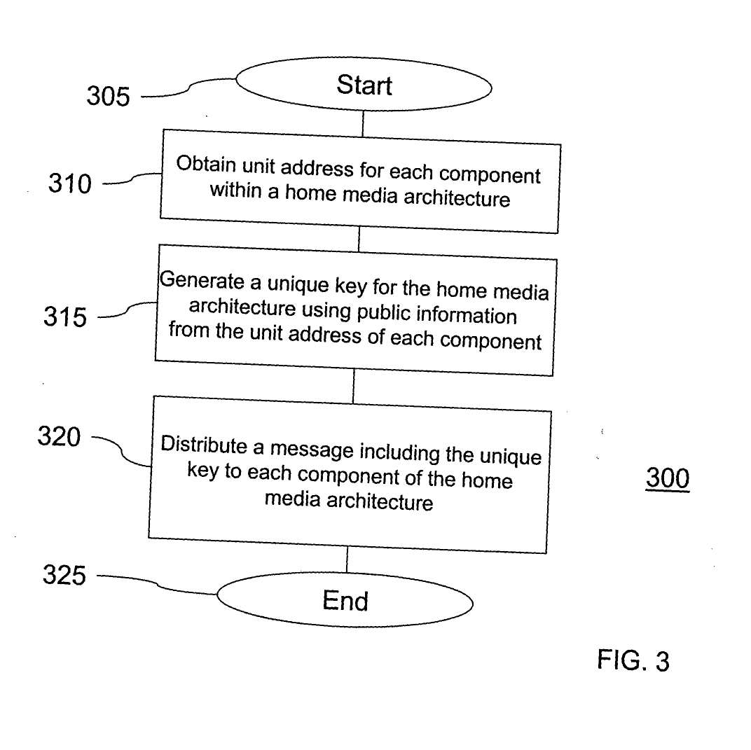

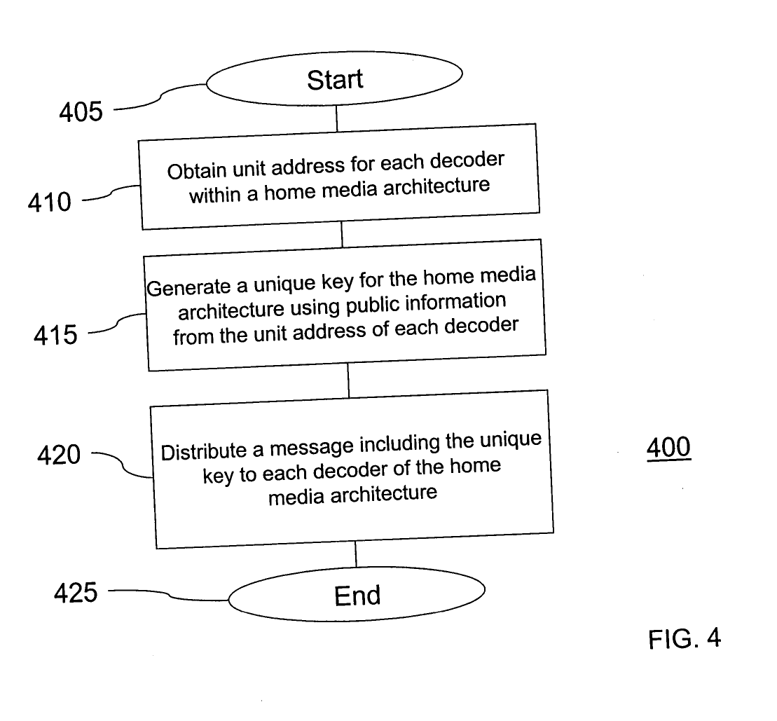

FIG. 3 illustrates a diagram of a method 300 for providing secured content distribution according to one embodiment of the present invention. FIG. 3 begins at step 305 and proceeds to step 310.

At step 310 unit addresses (UAs) of all components within a HMA are obtained. UAs are a unique identity for each encryptor/decryptor. At step 315 a unique key is generated for each component of the HMA using public information fro the UA of each component. At step 320 a message including the unique key is distributed to each component of the HMA.

Method 300 may be utilized to generate a hard drive encryption key at the headend. In one embodiment, the headend generates the local hard drive encryption key. The HMA may use a decoding chip's PVR_encryption key, e.g., DVR-encryption key, to encrypt DVR content when the media hub records content. The same key must be used by the media terminal to decrypt the content on playback. Taking advantage that all media hubs and media terminals are loaded with X.509 certificates during personalization phase in the factory, the same PVR_encryption key may be distributed securely among the media hub and media terminals within one HMA. This method gives the MSO control over which home consists of which media hub and media terminals.

In this embodiment, a new headend component, i.e., home group provisioner (HGP), is added to the headend. The HGP is a secure component that creates and distributes a unique key to all the components belonging to one HMA. The HGP is told the UAs of all components within a HMA—the media hub and its associated media terminals. HGP generates a content encryption key (CEK), e.g., DVR-encryption key, for this HMA. The CEK is encapsulated in a DCII message, e.g., a single-cast message. The CEK is encrypted by the public portion of the media terminal's encryption key. The message is further signed by the private portion of the HGP's signing key. A single-cast, unique message is created for each component. When a component receives this message, the component will authenticate that the message originates from HGP, then decrypts to obtain the key. In this manner, all components within one HMA will be loaded with the same CEK. In this embodiment, the authentication is between the HGP and each digital consumer terminal (DCT), e.g., media hub and media terminal(s), not among the DCTs within a HMA.

The DVR-key is associated with the media hub. When a media terminal moves from one HMA to another, it will be given the DVR-key of its new media hub. When the media hub moves to a new subscriber, a new DVR-key is generated for that new HMA. Thus previously recorded content will not be viewable by the new subscribers.

FIG. 4 illustrates a diagram of a method 400 for providing secured content distribution according to one embodiment of the present invention. FIG. 4 begins at step 405 and proceeds to step 410.

At step 410 unit addresses (UAs) of all components within a HMA are obtained. UAs are a unique identifier for each encryptor/decryptor. At step 415 a unique key is generated for each component, e.g., media terminal 130, 135, 140, of the HMA using public information from the UA of each component. At step 420 a message including the unique key is distributed to each component of the HMA.

Method 400 may be utilized to generate a hard drive encryption key locally, e.g., at the media hub. In one embodiment, the media hub generates the local hard drive encryption key. Upon formation of a HMA, the media hub obtains the UA of all the components, e.g., media terminals within this HMA. Other network parameters may also be needed, e.g., the IP address of each component. The media hub requests the public portion of the Reed-Solomon Association (RSA) key from each media terminal. In turn, the media hub sends each media terminal its public key.

The media hub generates a PVR_encryption key to be used to encrypt DVR content. The value of this PVR_encryption key will be encapsulated in a unique message for each media terminal. To protect the content of the PVR_encryption key so that the content is not compromised over the wire, the secured portion of the message is encrypted by the public key of the individual media terminal. Furthermore, the message is signed by the private key of the media hub.

When a media terminal receives a PVR_encryption_Key_distribution_message addressed to it, the media terminal decrypts the secured portion using its private key. The signature is verified using the public key of the media hub. If the verification is correct, the media terminal accepts the PVR_encryption key and programs the clear key into the decoding chip. Once all components inside a HMA are synchronized with the same PVR_encryption key, any content encrypted by the media hub can be decrypted by the media terminals.

While the foregoing is directed to embodiments of the present invention, other and further embodiments of the invention may be devised without departing from the basic scope thereof, and the scope thereof is determined by the claims that follow.

1. A method of providing secured content distribution using a media hub, comprising:
receiving conditional access encrypted content at the media hub;
decrypting the conditional access encrypted content;
re-encrypting the content in accordance with a unique tier associated with the media hub and one or more devices in response to a request from at least one device associated with the unique tier;
in response to said request from at least one device, providing the re-encrypted content to the at least one device associated with the unique tier.

2. The method of claim 1, wherein said one or more devices comprises one or more media terminals.

3. The method of claim 1, further comprising, storing the decrypted content in a personal video recorder.

4. The method of claim 3, wherein storing the decrypted content comprises:
personal video recorder encrypting the decrypted content; and
storing the content on the personal video recorder.

5. The method of claim 4, further comprising, retrieving the content from the personal video recorder.

6. The method of claim 5, wherein retrieving the content comprises:
decrypting the personal video recorder encrypted content; and
providing the content to the media hub.

7. The method of claim 1, wherein when re-encrypting said content, said media hub creates a program rekey message using said unique tier.

8. The method of claim 1, wherein said re-encrypted content is re-encrypted using a conditional access encryption technique.

9. An apparatus for providing secured content distribution, comprising:
means for receiving conditional access encrypted content;
means for decrypting the conditional access encrypted content;
means for re-encrypting the content in accordance with a unique tier associated with the apparatus and one or more devices in response to a request from the one or more devices associated with the unique tier;
means for providing the re-encrypted content to the one or more devices in response to said request from the one or more devices associated with the unique tier.

10. A method of providing secured content distribution, comprising:
obtaining a unit address for each component within a home media architecture;
generating a unique key for the home media architecture using public information from the unit address of each component; and
distributing a message including said unique key to each component of said home media architecture.

11. The method of claim 10, wherein said unique key is encrypted using a public portion of the UA of said component.

12. The method of claim 11, wherein said unique key comprises a digital video recorder key.

13. An apparatus for providing secured content distribution, comprising:
a headend component for obtaining unit addresses of all components within a home media architecture;
said headend component generating a unique key for the home media architecture using public information from the unit address of each component; and
headend component distributing a message including said unique key to each component of said home media architecture.

14. A method of providing secured content distribution, comprising:
obtaining a unit address for each decoder within a home media architecture;
generating a unique key for the home media architecture using public information from the unit address of each decoder; and
distributing a message including said unique key to each decoder of said home media architecture.

15. The method of claim 14, wherein said unique key is encrypted using a public portion of the UA of said component.

16. The method of claim 15, wherein said unique key comprises a digital video recorder key.

17. An apparatus for providing secured content distribution, comprising:
a media hub for obtaining unit addresses of all media terminals within a home media architecture;
said media hub generating a unique key for the home media architecture using public information from the unit address of each media terminal; and
said media hub distributing a message including said unique key to each media terminal of said home media architecture.
